(19) United States
(12) Patent Application Publication
(10) Pub. No.: US 2007/0039432 A1
(43) Pub. Date: Feb. 22, 2007

(54) Torque-Indicating Driver and Method

(76) Inventor: Brian James Cutler, Rowland Heights, CA (US)

Correspondence Address: ITALIA IP, 3500 WEST OLIVE AVE., SUITE 300, BURBANK, CA, 91505, US

(21) Appl. No.: 11/465,150

(22) Filed: Aug. 17, 2006

Related U.S. Application Data
(60) Provisional application No. 60/709,369, filed on Aug. 18, 2005.

(51) Int. Cl. B25B 23/142; B25B 23/159

(52) U.S. Cl. 81/478

(57) ABSTRACT

A torque-indicating driver that includes, a handle, a tube casing; a click arm with a fastener-engaging portion at one end that projects from the tube casing and operably coupled to a torque-limiting mechanism housed within the tube casing at the other, torque-adjusting mechanism within said handle and coupled to said torque-limiting mechanism for adjusting the torque-limiting mechanism to the desired torque value, and torque-indicating mechanism operably coupled to said click arm such that an indicator is activated to signal that the desired torque has been reached during the tightening of a fastener.

### CROSS-REFERENCE TO RELATED APPLICATION

This application claims the benefit of the filing date under 35 USC 119(e) of the filing date of U.S. Provisional Application Ser. No. 60/709,369, filed Aug. 18, 2005.

### BACKGROUND

This application relates generally to driving tools such as screwdrivers, nut drivers, bolt drivers, wrenches and the like wherein the amount of torque that the tool can apply to a given fastener is limited to a settable value and the user is given a signal or indication that the desired torque level has been obtained. More specifically, this application relates to torque indicating mechanisms, both mechanical and electrical, usable in said tools that identifies when the desired torque is reached, thereby preventing the user from overtorquing a given fastening device.

Torque settable and indicating drivers or wrenches as described above are well known in the art. This application relates to drivers that are able to give a user an improved indication that a desired torque level has been reached and is designed for uses where torque tolerances are critical. The need for a torque driver that can drive a given fastener at a desired torque value is useful in a variety of fields including sporting goods, electronics and computer assembly, and any other use where specific tolerances are required. However, it would be desirable if there were a tool that would allow a user an improved indication that the desired torque level has been obtained such that each time a fastener was torqued, the user was confident that the desired torque was properly obtained. It would also be desirable for such a tool to be low-cost and suitable for mass production without sacrificing precision.

### SUMMARY

This application discloses a torque-indicating driver that is economical to produce, of simple construction and capable of mass production, but also capable of providing a clear indication to a user that the desired torque level has been obtained.

In particular, this application discloses a torque-indicating driver that includes a handle, a tube casing, a click arm with a fastener-engaging portion that projects from said tube at one end and operably coupled to a torque-limiting means housed within said tube at the other, torque-adjusting means within said handle and coupled to said torque-limiting means for adjusting the torque-limiting means to a desired torque value, mechanical torque-indicating means operably coupled with said click arm such that a mechanical indicator is activated to signal that the desired torque has been reached.

This application also discloses a torque-limiting driver that includes a handle, a tube casing, a click arm with a fastener-engaging portion that projects from said tube at one end and operably coupled to a torque-limiting means housed within said tube at the other, torque-adjusting means within said handle and coupled to said torque-limiting means for adjusting the torque-limiting means to a desired torque value, electronic torque-indicating means operably coupled with said click arm such that an electrical indicator is activated to signal that the desired torque has been reached.

In a further embodiment, this application discloses a torque-limiting driver that includes a handle, a tube casing, a click arm with a fastener-engaging portion that projects from said tube at one end and operably coupled to a torque-limiting means housed within said tube at the other, torque-adjusting means within said handle and coupled to said torque-limiting means for adjusting the torque-limiting means to a desired torque value, electronic torque-indicating means operably coupled with said click arm such that an electrical indicator is activated to emit a first signal to indicate when the desired torque has been reached and a second signal to indicate when the desired torque has been exceeded.

In a further embodiment, this application discloses a method for indicating when a desired torque setting has been obtained by providing a torque-indicating mechanism coupled to a click arm and housed within a tube casing and coupled to a torque-limiting mechanism, setting a torque-adjusting mechanism coupled to said torque-limiting mechanism, and applying a force to the fastener engaged wrench thereby activating the torque-indicating mechanism.

In a further embodiment, this application discloses a method for indicating when a desired torque setting has been obtained and exceeded by providing a torque-indicating mechanism coupled to a click arm and housed within a tube casing and coupled to a torque-limiting mechanism, setting a torque-adjusting mechanism coupled to said torque-limiting mechanism, and applying a force to the fastener engaged wrench thereby activating the torque-indicating mechanism.

Further, this application discloses a torque-indicating driver that includes a handle, a tube casing, a click arm with a fastener-engaging portion that projects from said tube at one end and operably coupled to a torque-limiting means housed within said tube at the other, torque-adjusting means within said handle and coupled to said torque-limiting means for adjusting the torque-limiting means to a desired torque value, mechanical torque-indicating means operably coupled with said click arm such that a mechanical indicator is activated to signal that the desired torque has been reached and wherein the fastener-engaging portion is further characterized by having orientation means such that driver is always in the correct orientation which allows the user to tighten the fastener while taking advantage of the desired torque-limiting and torque-indicating means.

This application also discloses a torque-limiting driver that includes a handle, a tube casing, a click arm with a fastener-engaging portion that projects from said tube at one end and operably coupled to a torque-limiting means housed within said tube at the other, torque-adjusting means within said handle and coupled to said torque-limiting means for adjusting the torque-limiting means to a desired torque value, electronic torque-indicating means operably coupled with said click arm such that an electrical indicator is activated to signal that the desired torque has been reached and wherein the fastener-engaging portion is further characterized by having orientation means such that driver is always in the correct orientation which allows the user to tighten the fastener while taking advantage of the desired torque-limiting and torque-indicating means.

In a further embodiment, this application discloses a method for indicating when a desired torque setting has been obtained by providing a torque-indicating mechanism coupled to a click arm and housed within a tube casing and coupled to a torque-limiting mechanism, setting a torque-adjusting mechanism coupled to said torque-limiting mechanism, and applying a force to the fastener engaged wrench whereby the method is further characterized by orientating the driver correctly thereby allowing activation of the torque-indicating mechanism.

In a further embodiment, this application discloses a method for indicating when a desired torque setting has been obtained and exceeded by providing a torque-indicating mechanism coupled to a click arm and housed within a tube casing and coupled to a torque-limiting mechanism, setting a torque-adjusting mechanism coupled to said torque-limiting mechanism, and applying a force to the fastener engaged wrench whereby the method is further characterized by orientating the driver correctly thereby allowing activation of the torque-indicating mechanism.

### BRIEF DESCRIPTION OF THE DRAWINGS

The drawings, when considered in connection with the following description, are presented for the purpose of facilitating an understanding of the subject matter sought to be protected.

FIG. 1 is perspective view of a torque-indicating driver;

FIG. 2 is a perspective view of the driver FIG. 1 under a force to activate a first embodiment of the indicating mechanism;

FIG. 3 is a sectional view of the driver taken generally along the line 3-3 in FIG. 1;

FIG. 4 is a sectional view of the driver taken generally along the line 4-4 in FIG. 2;

FIG. 5 is front elevational view of the fastener-engaging portion of the driver in FIG. 1;

FIG. 6 is a top elevational view of the fastener-engaging portion of the driver in FIG. 1;

FIG. 7 is a top elevational view showing the internal indicating mechanism of the driver in FIG. 1;

FIG. 8 is a view similar to FIG. 7 but showing the parts in different relative positions;

FIG. 9 is a schematic top elevational view showing the second embodiment of the indicating mechanism;

FIG. 10 is schematic top elevational view, and circuit diagram showing the second embodiment of the indicating mechanism of FIG. 9;

FIG. 11 is a view similar to FIG. 10 but showing the parts in different relative positions;

FIG. 12 is a view similar to FIG. 10 but showing the parts in different relative positions;

FIG. 13 is a schematic top elevational view of the indicating means of the present invention used in a driver with a known torque-limiting means;

FIG. 14 is a schematic top elevational view of the indicating means of the present invention used in a driver with a known torque-limiting means;

FIG. 15 is a schematic top elevational view of the indicating means of the present invention used in a driver with a known torque-limiting means.

### DETAILED DESCRIPTION

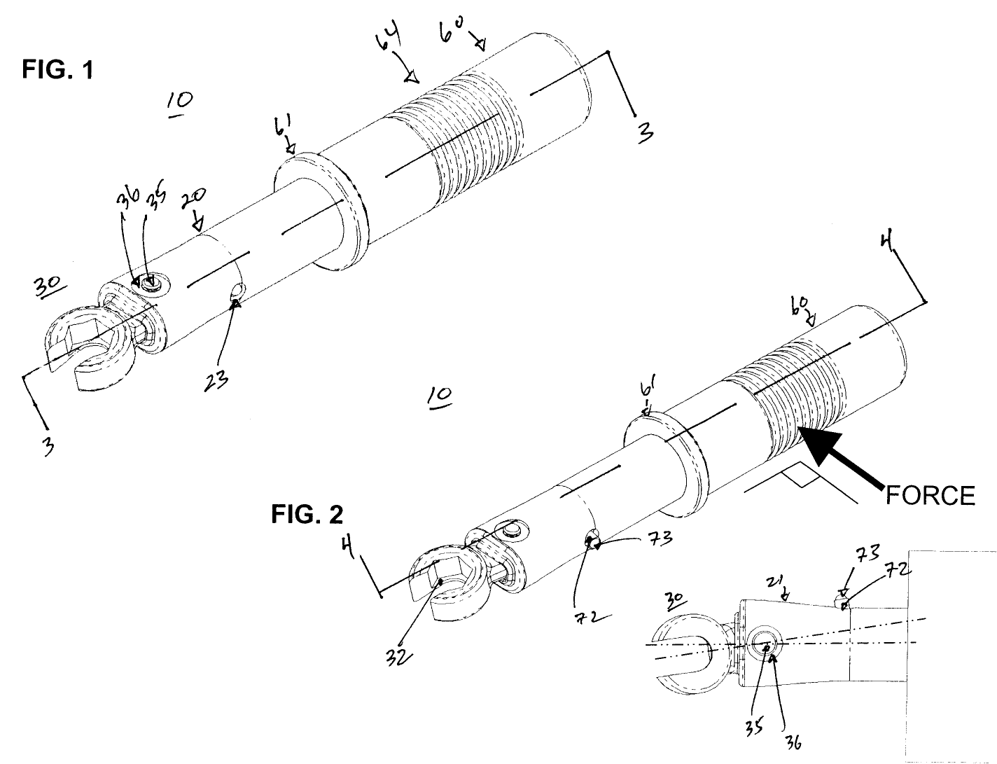

Referring to FIGS. 1-4, shown therein and generally designated by the reference character 10 is the preferred embodiment of the toque-indicating driver 10 constructed in accordance with the following description. The driver 10 includes a tube casing 20, a fastener-engaging portion 30, torque-limiting mechanism 40, adjusting mechanism 50, a tubular handle member 60, and an indicating mechanism 70.

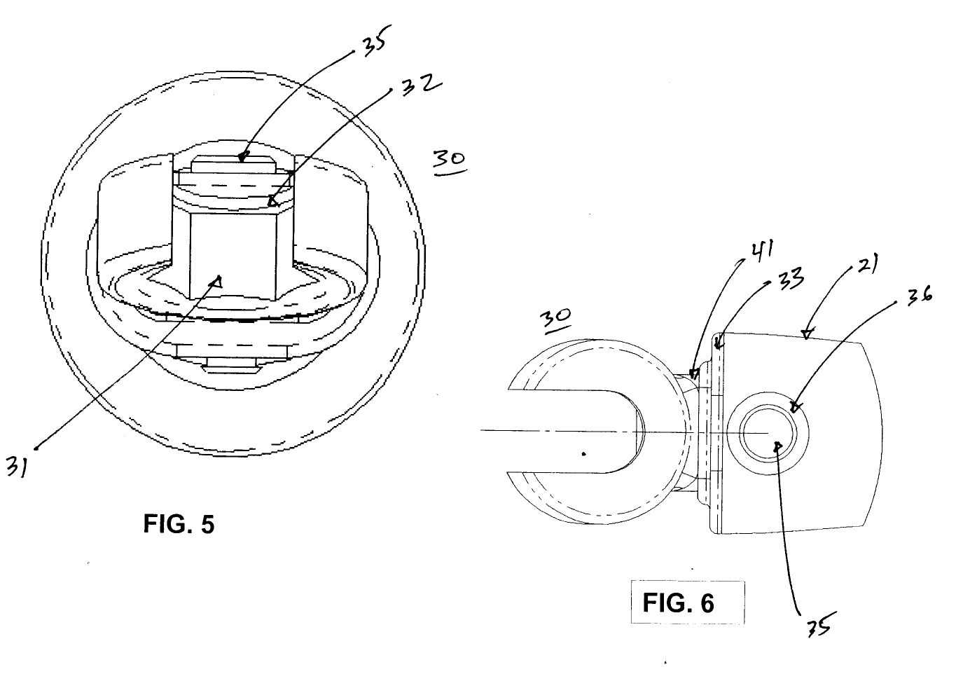

As may be seen more clearly in FIGS. 5 and 6, the fastener-engaging portion 30 is adapted to engage a fastener (not shown), and includes a hexagonal shaped inner surface 31 adapted to receive a bolt or nut type fastener. The upper surface of the fastener-engaging portion 30 may include driver orientation means such as an orientation limiting rim 32 that ensures that driver is in the correct orientation when the operator attaches it to a given fastener. The correct driver orientation allows the user to tighten the fastener while taking advantage of the desired torque-limiting and torque-indicating means. The fastener-engaging portion 30 is integral with a click arm 41 that extends through a rubber seal 33 and into the flared end 21 of the tube casing 20 and is mounted pivotally to the flared end 21 of the casing by means of a pivot pin 35 that is mateably received by a spacer 36. The distal end of the click arm 41 is operably associated with the torque-limiting mechanism 40 as discussed in more detail below.

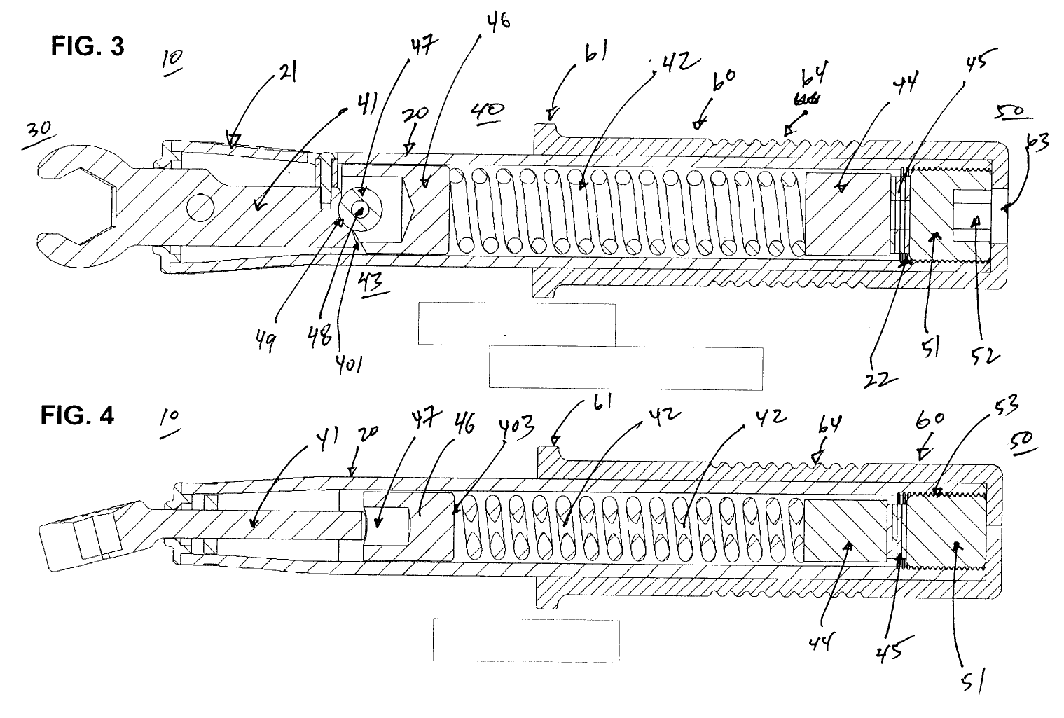

As may be seen more clearly in FIGS. 3 and 4, the torque-limiting mechanism 40 disposed in tube casing 20 is well known in the prior art and includes a spring 42, a cam assembly 43, click arm 41, first and second spacing shims 44, 45, and an adjustment plug 51. First and second spacing shims 44, 45 are in integral contact with one another and with the compressed spring at one end of the first shim 44 and the adjustment plug 51 at the end of shim 45. The spring 42 is disposed between the first shim 44 and the cam assembly 43, which is comprised of a body 46 and a roller 47 mounted rotatably to said body by means of a rotatable pin 48, and serves to create a force when compressed on the cam assembly 43 which engages the roller 47 into the distal end of the click arm 41, more specifically, the detent radius 49 of said click arm. The distal end of the click arm 41 also includes an angled edge 401 that receives the roller 47 when the force applied to the driver overcomes the force of the spring 42 upon the cam assembly 43, more specifically, the came face 403, as discussed in more detail below.

As may be more clearly seen in FIGS. 1 and 3, tubular handle member 60 is formed as a hollow cylindrical tube that is fixedly attached to a portion of the tube casing 20 and includes a handle grip hilt portion 61 at one end, an axial bore at the other 63 to allow access to the adjustment plug 51 seated below, and a griping mean 64 intermediate to each end.

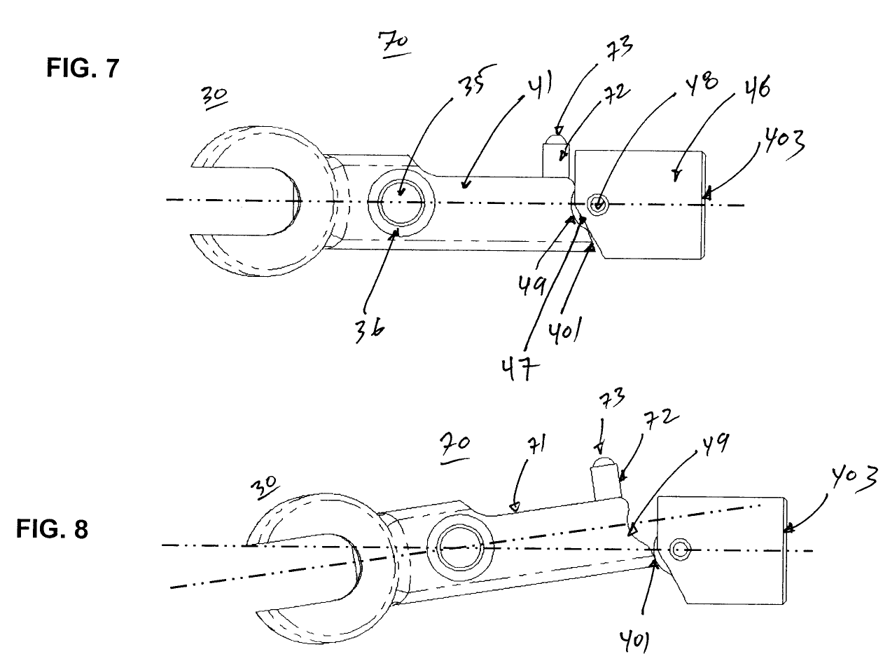

The indicating mechanism 70 is shown in FIGS. 1 and 2, and more specifically in FIGS. 7 and 8. The first embodiment of the indicating mechanism 70 includes the click arm 41 with a first lateral surface 71 and an indicator 72 fixedly attached to said surface 71 by a fastening means 73. As the click arm 41 is displaced due to a radial force on the handle that exceeds the spring force on the cam assembly 43 (discussed in more detail below), the indicator passes through a bore 23 in the tube member 20 thereby providing the operator with a visual indication that the fastener has been torqued the predetermined amount (FIG. 2). When the force applied by the operator is lessened to a level below the spring force on the cam assembly 43 the indicator 72 recedes back into the tube casing 20.

In use, the adjustment of the driver 10 is accomplished by utilizing the adjusting mechanism 50, which includes the adjustment plug 51, which is characterized by having a socket 52 at its distal end that is mateably shaped to receive an adjustment tool (not shown) and further characterized by an annular externally threaded surface 53 that is mateably received by the internally threaded surface 22 of the tube member 20. As the adjustment plug 51 is rotated to cause axial movement, this in turn creates an axial force on torque-limiting mechanism; namely, the first and second spacing shims 44, 45, and compression of the spring 42 against the cam assembly 43. The spring 42 can be compressed to correspond to a desired torque limit. The torque limit of the driver 10 can be adjustable by a user or fixed at a specific setting once assembled. When a radial load is applied to the tubular handle member 60 in a direction perpendicular to the axis of the driver 10 and on a parallel plane consistent with the click arm 41 the torque moment force rises on the fastener engaged by the fastener-engaging portion 30 to the desired torque setting which causes the roller 47 to lift from the detent radius 49 and as more force is applied by the operator, onto the angled edge 401 (FIG. 8). As the torque applied by the user exceeds the force of the spring 42 and the roller 47 is lifted from the detent radius 49, the indicator 72 is extended through the bore 23 in the tube casing 20 and exposed to the user as a visual indication that the applied load on the handle member 60 has reached the desired torque setting of the driver 10. The angled edge 401 allows the click arm 41 to be forced by the roller 47 back to the start location in the detent radius 49 by the force of the spring 42 as the force against the handle 60 is reduced, thereby allowing the indicator 72 to retract back below the surface of tube casing 20.

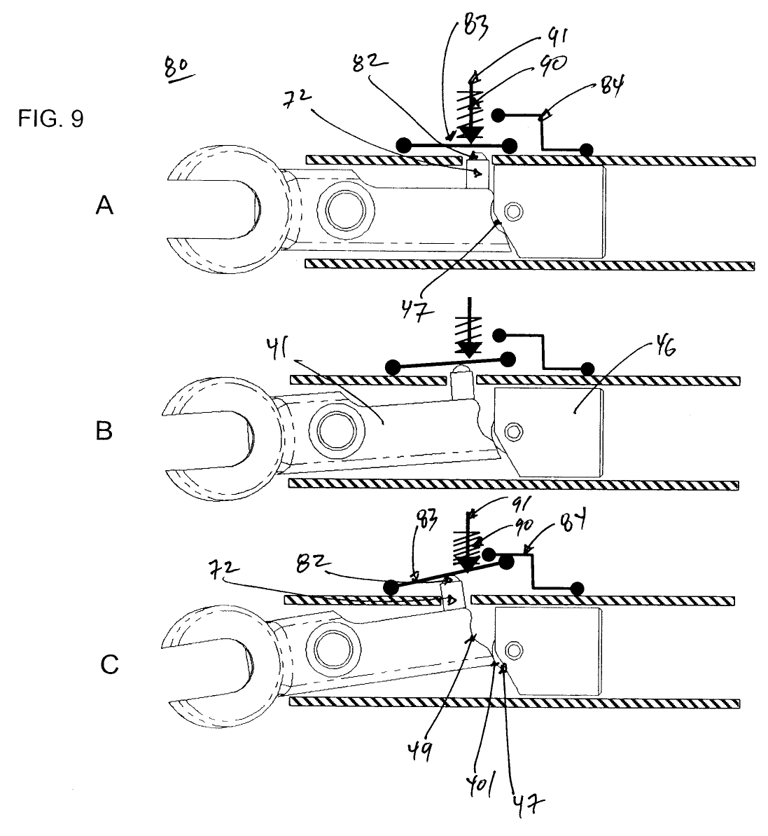

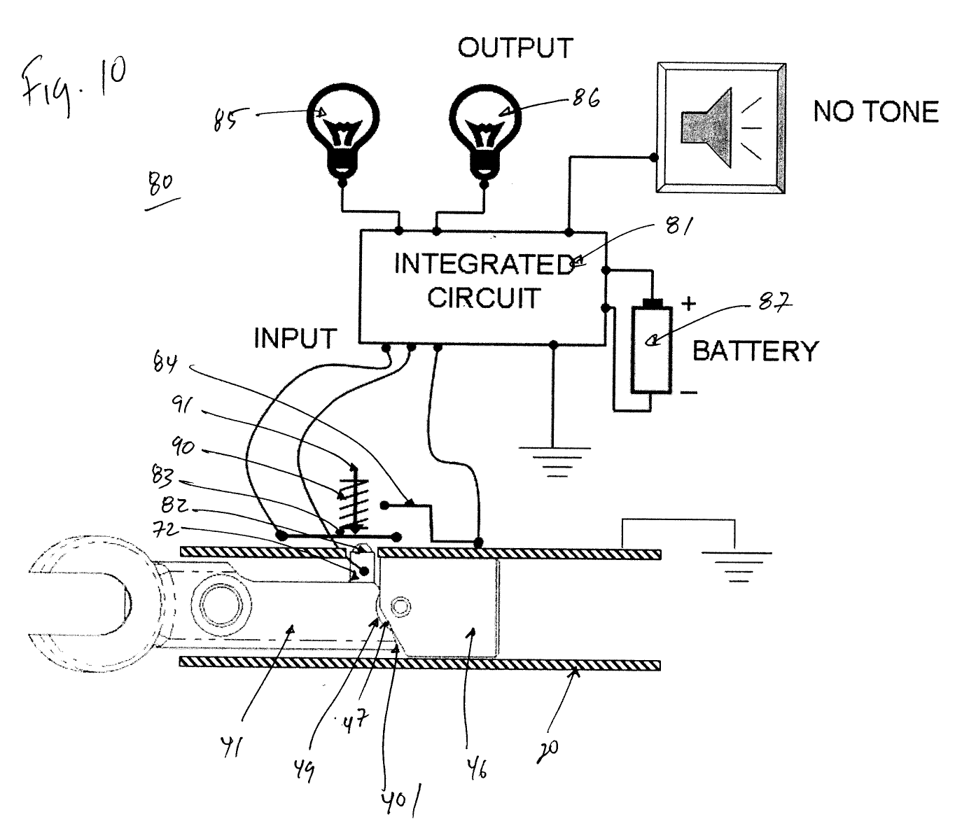

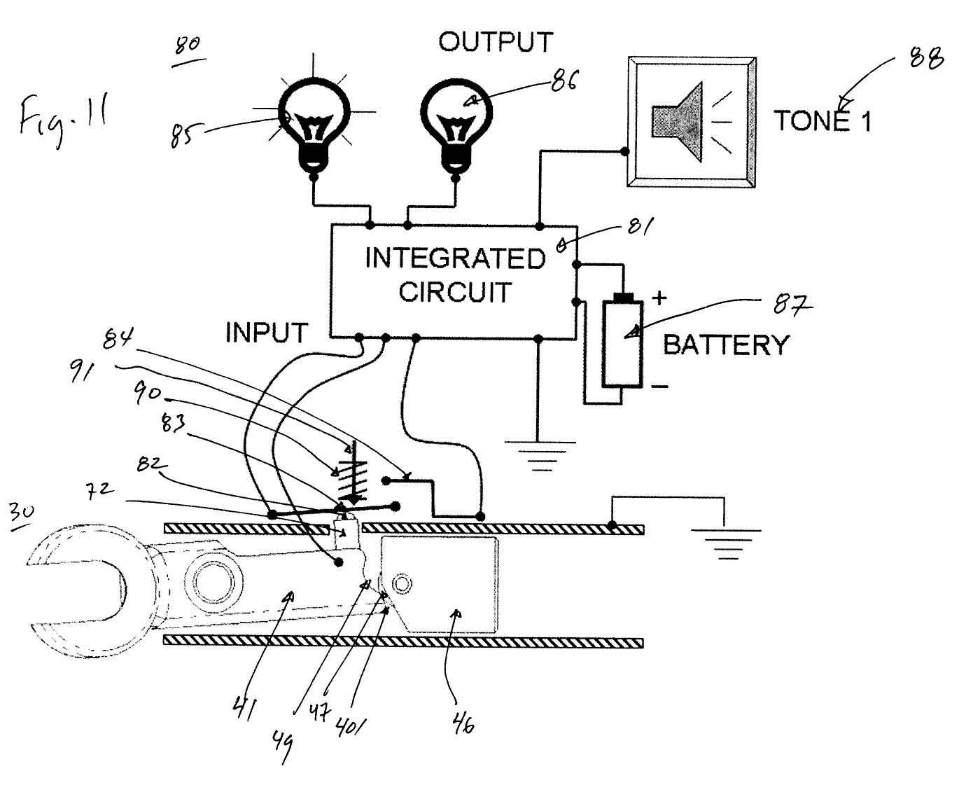

The second indicating mechanism embodiment 80 of the indicating mechanism 70 is shown in FIGS. 9-12. In this embodiment, the mechanical indicating mechanism described above is adapted to close a series of circuits thereby creating a signal (visual and/or auditory) to the operator that a predetermined torque on the fastener has been reached and/or exceeded. The second embodiment 80 of the indicating mechanism includes the indicating mechanism 70, an integrated circuit 81, a first contact 82 located on the end of the indicator 72, a second contact 83 operably adjacent to the first contact 82, a third contact 84 operably adjacent to the second contract 83 and operably separated from the second contact 83 by a spring 90 which includes spring support and adjustment means 91, which may be either a shim or screw (not shown), a first visual indicator 85, a second visual indicator 86, and a battery 87. In another embodiment, a first auditory indicator 88 and second auditory signal 89 may be used instead of or in addition to the visual indicators.

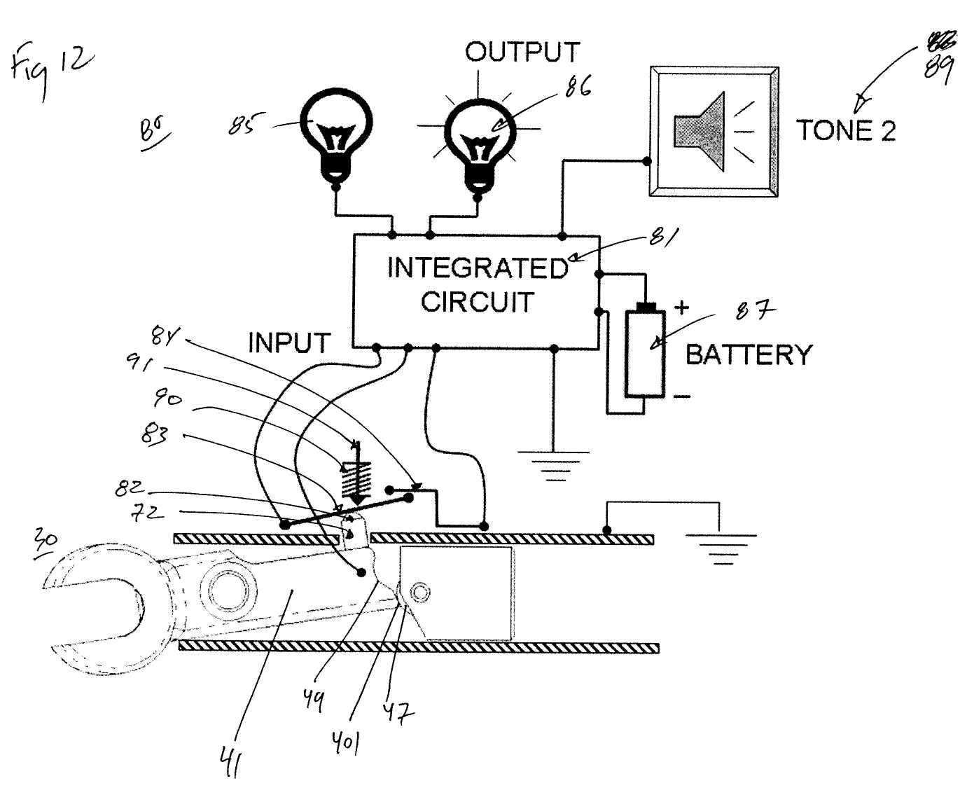

The relative positions of the indicator 72 are shown in FIG. 9. Position A represents when the wrench is either at rest or when the torque applied to the fastener is below the predetermined level. At position A the indicator 72, with its first contact 82, is not in contact with either the second contact 83 or third contact 84. At position A no signal is generated. See FIG. 10. Position B represents when the predetermined torque has been reached. At position B a radial force is applied to the tubular handle member 60 in a direction perpendicular to the axis of the driver 10 at a sufficient force to overcome the force by the spring 42 on the cam assembly 43 causing the roller 47 to lift from the detent radius 49 which forces the click arm 41, with its indicator 72, and its first contact 82, to come in contact with the second contact 83. With the first 82 and second contacts 83 engaged, the circuit is closed and a signal is sent to the integrated circuit 81, which results in the first visual indicator 85 and/or first auditory signal 88 to be activated thereby signaling to the operator that the desired torque on the fastener has been obtained. See FIG. 11. The second contact 83 is supported by a spring 90 with adjustable force means, such as shims or a screw (not shown). The force on the spring 90 resists the travel of the second contact 83 as load is increased. As the load is increases, the roller 47 rises further out of the detent radius 49 and begins to come in contact with the angled edge 401 thereby increasing the deflection of the second contact 83 leading to circumstance found in position C. Position C represents when the predetermined torque has been exceeded. At position C the indicator 72, with its first contact 82, is in contact with the second contact 83 and has sufficiently compressed the spring 90 such that the second contact 83 is contact with the third contact 84. Here the predetermined force applied by the spring 90 is directly relative to the defined percentage of the predetermined torque value. At position C the roller 47 is sufficiently deflected and is now on the angled edge 401 of the click arm 41. With the second 83 and third contacts 84 engaged, the circuit is closed and a signal is sent to the integrated circuit 81, which results in the second visual indicator 86 and/or second auditory signal 89 to be activated thereby signaling to the operator that the desired torque on the fastener has been exceeded. See FIG. 12.

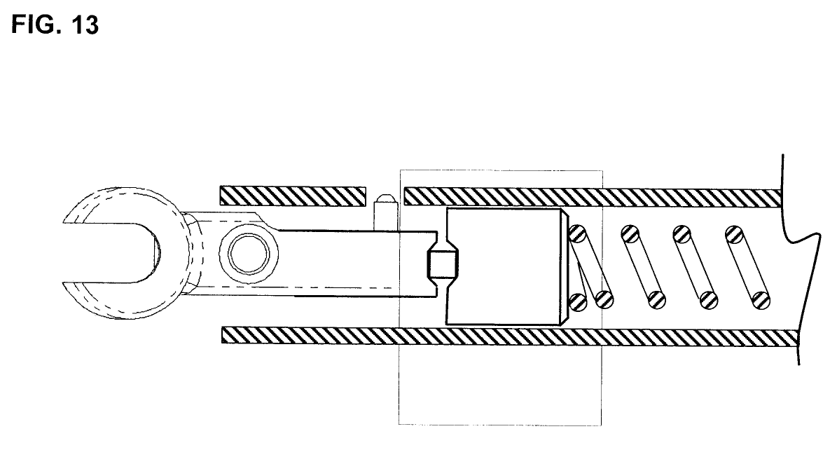

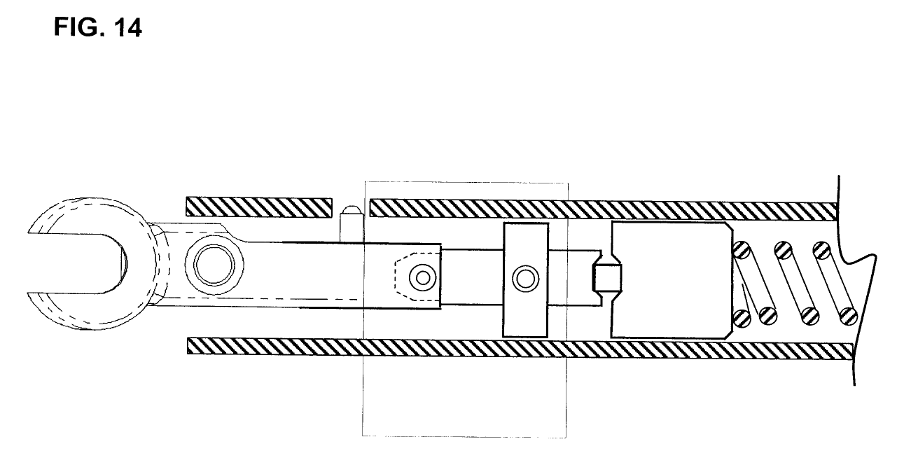

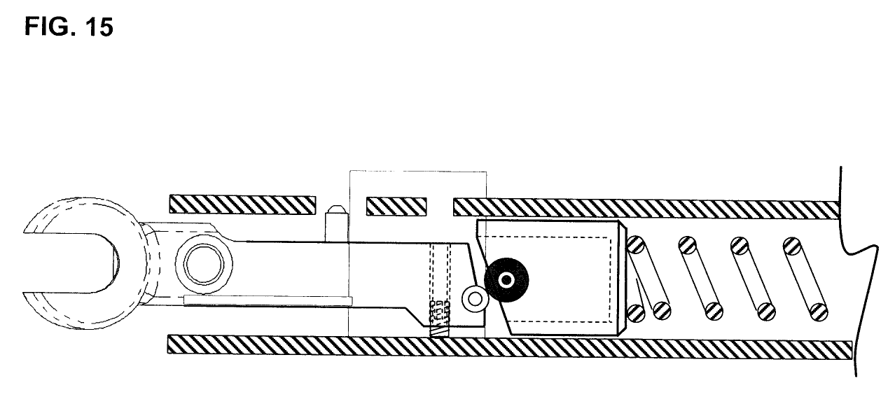

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements. To that end, various torque-limiting mechanisms are known in the prior art that are adaptable to the disclosed indicating means. Examples of such known torque-limiting mechanisms (shown with the present novel disclosure added) include: a tilting pawl mechanism (FIG. 13), a tilting pawl with a secondary arm mechanism (FIG. 14), and an overriding cam mechanism (FIG. 15). These examples are not meant to be an exhaustive list of the possible torque-limiting mechanisms adaptable to the disclosed indicating means nor better than the torque-limiting mechanism shown in the preferred embodiment.

What is claimed is:

1. A torque-indicating driver comprising:
a handle;
a tube casing;
a click arm with a fastener-engaging portion at one end that projects from the tube casing and operably coupled to a torque-limiting means housed within the tube casing at the other;
torque-adjusting means within said handle and coupled to said torque-limiting means for adjusting the torque-limiting means to the desired torque value;
torque-indicating means operably coupled to said click arm such that an indicator is activated to signal that the desired torque has been reached.

2. The torque-indicating driver of claim 1 wherein the torque-indicating means comprises mechanical torque-indicating means.

3. The torque-indicating driver of claim 2 wherein the mechanical torque-indicating means comprises an indicator fixedly attached to the click arm such that when the desired torque is reached, the indicator is observed by the user.

4. The torque-indicating driver of claim 3 wherein the driver comprises a bore in the tube casing that the indicator passes through and is observable to the user when the desired torque is reached.

5. The torque-indicating driver of claim 4 wherein the indicator recedes back through the bore when the torque applied by the user is reduced below the desired torque setting.

6. The torque-indicating driver of claim 5 wherein the fastener-engaging portion of the click arm further comprises driver orientation means for ensuring that the driver is in the correct orientation when the user attaches it to a given fastener.

7. The torque-indicating driver of claim 1 wherein the torque-indicating means comprises electronic torque-indicating means.

8. The torque-indicating driver of claim 7 wherein the electronic torque-indicating means comprises an indicator that is fixedly attached to the click arm at one end and includes a first contact at the other, such that when the desired torque is reached, the first contact engages a second contact thereby closing a circuit and signaling to the user that the desired torque has been reached.

9. The torque-indicating driver of claim 8 wherein the signal is a visual and/or auditory.

10. The torque-indicating driver of claim 9 wherein the first contact disengages from the second contact when the torque applied by the user is reduced below the desired torque setting.

11. The torque-indicating driver of claim 10 wherein the fastener-engaging portion of the click arm further comprises driver orientation means for ensuring that the driver is in the correct orientation when the user attaches it to a given fastener.

12. The torque-indicating driver of claim 8 wherein the electronic torque-indicating means further comprises a third contact such that when the desired torque is exceeded, the third contact is engaged with the second contact thereby closing a circuit and signaling to the user that the desired torque has been exceeded.

13. The torque-indicating driver of claim 12 wherein the signal is a visual and/or auditory.

14. The torque-indicating driver of claim 13 wherein the second contact disengages from the third contact when the torque applied by the user is reduced below the exceeded torque setting.

15. The torque-indicating driver of claim 14 wherein the fastener-engaging portion of the click arm further comprises driver orientation means for ensuring that the driver is in the correct orientation when the user attaches it to a given fastener.

16. A method for indicating when a desired torque setting has been obtained when using a torque-indicating driver to secure a fastener comprising:
providing a torque-indicating mechanism coupled to a click arm and housed within a tube casing and coupled to a torque-limiting mechanism;
setting a torque-adjusting mechanism coupled to said torque-limiting mechanism, and;
applying a force to the fastener engaged driver thereby activating the torque-indicating mechanism when the desired torque is obtained.

17. The method of claim 16 wherein the torque-indicating mechanism comprises mechanical torque-indicating means wherein the mechanical torque-indicating means comprises an indicator fixedly attached to the click arm such that when the desired torque is reached, the indicator is observed by the user.

18. The method of claim 17 wherein the driver comprises a bore in the tube casing that the indicator passes through and is observable to the user when the desired torque is reached.

19. The method of claim 16 wherein the torque-indicating mechanism comprises electronic torque-indicating means wherein the electronic torque-indicating means comprises an indicator that is fixedly attached to the click arm at one end and includes a first contact at the other, such that when the desired torque is reached, the first contact engages a second contact thereby closing a circuit and signaling to the user that the desired torque has been reached.

20. A method for indicating when a desired torque setting has been obtained and exceeded when using a torque-indicating driver to secure a fastener comprising:
providing an electronic torque-indicating mechanism coupled to a click arm and housed within a tube casing and coupled to a torque-limiting mechanism;
setting a torque-adjusting mechanism coupled to said torque-limiting mechanism, and;
applying a force to the fastener engaged driver thereby activating the electronic torque-indicating mechanism when the desired torque is obtained, wherein the electronic torque-indicating mechanism comprises an indicator that is fixedly attached to the click arm at one end and includes a first contact at the other, such that when the desired torque is reached, the first contact engages a second contact thereby closing a circuit and signaling to the user that the desired torque has been reached, and wherein the electronic torque-indicating mechanism further comprises a third contact such that when the desired torque is exceeded, the third contact is engaged with the second contact thereby closing a circuit and signaling to the user that the desired torque has been exceeded.
